(19) United States
(12) Patent Application Publication
(10) Pub. No.: US 2010/0108170 A1
(43) Pub. Date: May 6, 2010

(54) Crush resistant stay put hose

(76) Inventors: Frank Chudkosky, Anderson, SC (US); Ken Campbell, Greenwood, SC (US)

Correspondence Address: Thomas A. O'Rourke;Bodner & O'Rourke, 425 Broadhollow Road, Melville, NY, 11747, US

(21) Appl. No.: 12/291,166

(22) Filed: Nov. 6, 2008

(51) Int. Cl. F16L 11/11; B29D 23/18

(52) U.S. Cl. 138/122; 156/144; 138/129; 138/134

(57) ABSTRACT

A crush resistant and stay put hose is provided. There is a helical member having a plurality of coils and a wall surface of one or more thermoplastic polymer layers. The layers extend from one coil to the next and the wall surface between the coils has at least one living hinge. When one portion of the hose is in an extended condition, the hose remains in the extended condition without reverting to the unextended condition. Methods of making the hose are also disclosed.

### FIELD OF INVENTION

This invention relates to a stay put hose for transporting fluids that is flexible and crush resistant.

### BACKGROUND OF THE INVENTION

Flexible hoses are used in a variety of applications. These hoses typically have a helical member that is made of metal, plastic or a plastic coated metal. The helical member provides a frame for a thermoplastic layer that is the body of the hose. The helical member can be an electrical wire if desired. Alternatively, there can be one or more electrical wires adjacent to the helical member or elsewhere in the body of the hose. The helical member may be made of metal or plastic.

Flexible hoses may be manufactured by a variety of means. Some traditional approaches are shown in U.S. Pat. No. 3,155,559 to Hall, U.S. Pat. No. 3,271,064 to Hall, U.S. Pat. No. 3,548,724 to Hall and U.S. Pat. No. 4,213,811 to Hall the disclosures of which are incorporated herein by reference. The hoses shown in the Hall patents have a plastic outer layer circumferentially applied over a helical wire that is positioned on a belt on a mandrel.

There are a number of different configurations possible for the flexible hoses. Depending on the arrangement of the helical core and the outer layer or layers there can be, for example, retractable hoses that can extend by applying a force to one end of the hose pulling the hose from away from the opposite end. When the force is released the hose retracts to its original size. There are also extensible hose that can be extended 2-3 times or more of its ordinary length by applying a force to the end of the hose outwardly.

While flexible hoses are used most commonly with vacuum systems, there are many applications both indoors and outdoors where flexible hoses can be found. Because of the varied environments that the hoses are used in there is some times a need for a flexible hose that is crush resistant. While most hoses having a metal helix provide some resistance to crushing because of its strength, not all of these metal hoses are truly considered to be crush resistant. In a metal supported hose, a force on the hose will sometimes cause the metal helix to bend. If the amount of force is too great, the hose will be permanently deformed and the hose will not return to its original shape when it's removed. A hose having a plastic helix is usually more crush resistant because the plastic helix does not permanently deform easily and has a tendency to more readily return to the original hose shape once the force is removed.

Many hoses and tubing have a memory. When a hose is extended or compacted there is a tendency for the hose to return to its original configuration. Even in situations where a hose is bent or angled it has a tendency to return to its normal or original position when a force is removed. This is most easily seen in retractable hoses where a hose is extended during use. When the use is complete the hose retracts back to its original position when the extensions force is removed from the hose.

Hoses that do not have this memory property are called “stay put” hoses. A stay put hose may be bent to go around an obstruction, it may be extended, it may be retracted or a combination there of. When it is positioned into a particular configuration a stay put hose will retain that configuration. In one example a stay put hose may be one that is trailed along a floor from location to another. The hose will stay in that position as it is lying on the floor or other surface and will not attempt to return to its original configuration. There is also a need at times for a crush resistant hose that is also a stay put hose.

While most hoses are flexible and intended to be very compliant when bent and flexed into position, they have an inherent tendency to return to their original position due to the elasticity of their materials. The class of hoses termed “stay-put” hoses are able through material choices and geometry to stay in a position set by the user of the hose, not unlike a drinking straw where the upper portion of the straw can be bent into a more suitable position for drinking and remain in that position.

The current state-of-the-art for stay-put hoses utilizes steel wire as the helix, which produces a usable product with two significant drawbacks: weight and crushability. Since a stay-put hose in its collapsed state is very compact, ⅓ or less of its extended length, a substantial amount of steel wire is required to produce the product, thereby increasing product weight. The steel wire helix will also take a set if the hose were stepped on or crushed incidentally in some other fashion.

An alternative to a steel wire helix stay put hose product is a plastic helix stay-put hose where the steel wire helix is eliminated and replaced with an extruded plastic helix, thereby reducing weight and increasing it's resistance to being crushed. While this is very simple to describe in theory, in practice the art of producing such a hose is difficult since the design of the hose needs stay open and stay closed simultaneously to effectively produce the desired behavior

### OBJECTS OF THE INVENTION

It is an object of the invention to provide an improved stay put hose.

It is an object of the invention to provide an improved stay put hose in an area supported at either end and compressed would resist bending due to gravity.

It is also an object of the invention to provide an improved crush resistant hose.

It is another object of the invention to provide a improved crush resistant stay put hose

It is a further object of the invention to provide a hose with increased resistance to abrasion particularly in applications where the hose is used on concrete blacktop etc.

### SUMMARY OF THE INVENTION

The present invention is directed to an improved stay put hose of a unique construction. The hose of the present invention also has crush resistant properties. The hose in general has a helix of metal or plastic. The hose typically has a wall surface of one or more layers of a thermoplastic material. The helix can be on the outer surface of the thermoplastic layer or on the inner surface of the hose. Alternatively, the helix can be adjacent to the outer thermoplastic layer or layers but on the inside surface of the thermoplastic layer. Where the helix is made of metal the helix is preferably on the inner surface of the hose. Where the helix is made from a thermoplastic material the helix is preferably on the outer surface of the hose.

In a still further embodiment of the invention, there can be a helix with one or more thermoplastic layers on each side thereof. Having the helix on the outer surface of the hose provides the additional benefit to the user. This surface acts as a sacrificial surface to aid in resistance to abrasion in applications where the hose is on a rough surface such as concrete, black top, gravel, etc. This outer helix provides resistance to abrasion for these and other outdoor type uses.

To achieve the stay put properties of the hose the helix must be neutral and not provide any bias to being open and closed. By open is meant in an extended condition. By closed is meant in a retracted position. In a preferred embodiment the helix is a plastic helix although a metal helix could be used as well. In forming the hose of the present invention the plastic helix is preferably extruded in place on the hose during formation of the hose so that it has minimal or no bias and does not contribute a force to keeping the hose open or closed. Since the helix does not contribute to the behavior of a plastic stay put hose the configuration of the wall becomes significant to the operation and behavior of the hose. The wall material of the hose of the present invention is a thermoplastic material. Suitable thermoplastic materials include but are not limited to TPE (thermoplastic elastomer ), and polypropylene and blends there of TPO (thermoplastic olefin) and blends with these and other thermoplastic materials.

The wall material is a thermoplastic material of sufficient hardness and flexibility that, in combination with its generally V-shaped cross-section, has two preferential states (fully open and fully closed) without the ability to stay in an intermediate position. Thus, each individual wall section between helical members can remain either open or closed as desired. These preferential states are enhanced by the geometry of the wall construction where a substantial length of one side of the ‘V’ cross-section is twice as thick as the nominal wall-thickness of the other side V cross section, which forces the opposing side of the wall to accommodate the majority of the flexing necessary to open and close. In addition, at least one and preferably two living hinges are created at the bottom of the ‘V’ by introducing a weighted roller to the wall plastic while still hot during the manufacturing process. Furthermore, the ‘V’ cross-section is asymmetric, where one leg of the ‘V’ is longer than the opposing leg, which promotes a shingling effect to the interior maximizing the internal diameter of the compressed hose and reducing drag of the media passing through the hose.

### BRIEF DESCRIPTION OF THE DRAWINGS

FIG. 1 shows one embodiment of the stay put hose of the present invention with a center portion extended.

FIG. 2 shows the embodiment of FIG. 1 in an alternative position where the stay put hose is given an “S” shape.

FIG. 3 is a side view of a portion of the hose of FIG. 1.

FIG. 4 is a side view of the hose during the manufacturing process with the hose with internal helix on the teeth of a belt on the mandrel.

FIG. 5 is a side view of the hose of FIG. 4 with additional layers present and external helix.

FIGS. 6A and 6B are side views of a preferred belt configurations for the formation of the hose of the present invention.

FIG. 7 shows the arrangement of the plurality of teeth on the belt with conductive members present

FIG. 8 shows an alternative arrangement of the belt of the present invention.

FIG. 9 shows a cutaway view of a portion of the hose of FIG. 1

FIG. 10 shows an enlarged portion of the hose of FIG. 9.

FIG. 11 shows the arrangement of the teeth when the roller forces the wall material into a recess in the tooth to form the living hinge.

### DETAILED DESCRIPTION

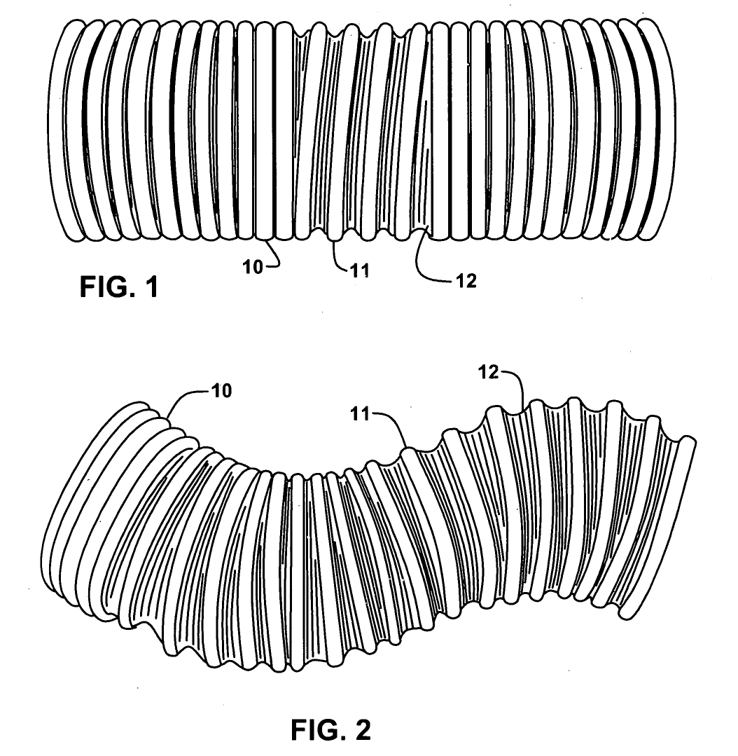

FIG. 1 shows an example of the stay put hose 10 of the present invention. The hose 10 has a helical member 11 that is on the outer surface of the hose, each section of the helical member is separated by a wall surface that is a flexible member 12. As can be seen from FIG. 1, the stay put hose 10 has been partially extended such that the center portion has been extended but the ends have not and remain in their retracted configuration. Even though the force extending the center portion has been removed, that portion of the hose remains in its extended position. Similarly, in FIG. 2 the stay put hose 10 has been arranged in an “S” shape and the hose remains in that position when the forces that placed the hose in that position are removed.

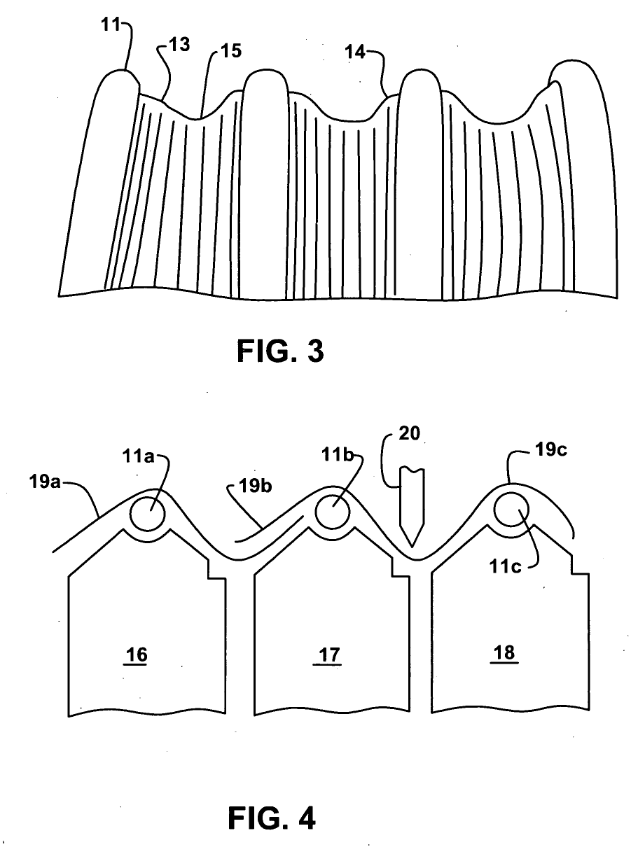

FIG. 3 shows a portion of the side view of the hose of FIG. 1. The wall material 12 has a generally “V” shape. There are two legs of the “V”, a left leg 13 and a right leg 14. As can be seen from FIG. 3, the left leg is slightly longer than the right leg. Because the left leg is slightly longer than the right leg, the apex 15 of the “V” is not centered between the two adjacent helical members 11. The helical members can be made of a metal or a suitable plastic. In these FIGS. 1 to 3, the helical member has a plastic outer surface. This outer surface can be present because there is a plastic, helical member or the helical member is made from a metal and coated with plastic. The helical member's plastic outer surface provides a protective surface to reduce problems from abrasion if the hose is moved across a rough surface such as concrete, black top or the like. The plastic covering on the helical member also aids in heat fusing the helical member to the wall material. The plastic covering can also have electrical insulation properties when the metal is used an electrical conductor.

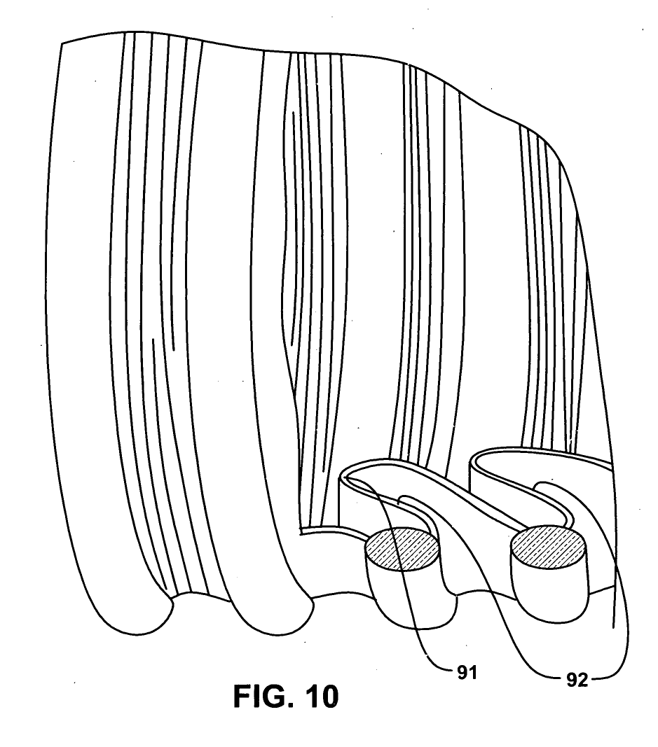

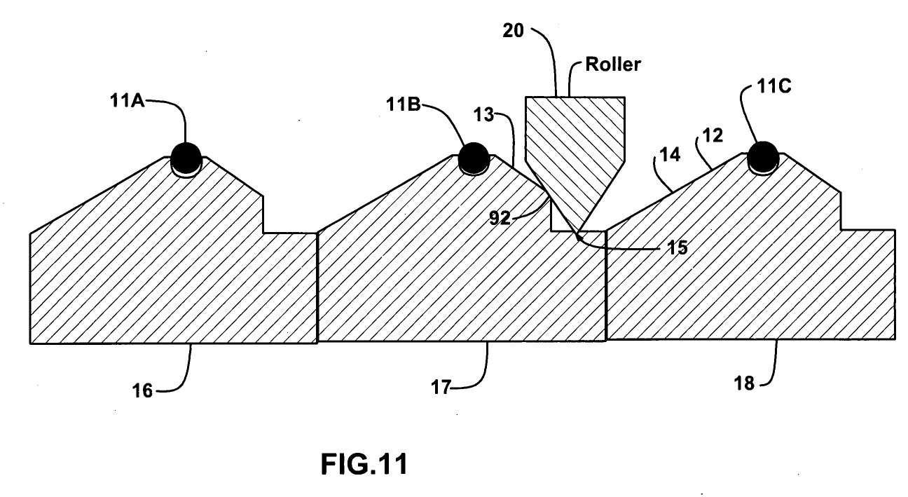

One of the advantages of the “V” shaped all surface where one leg is longer than the other leg is that when the hose is in a collapsed configuration as opposed to an expanded condition, the wall surface of the hose folds into a shingle effect that permits low turbulent flow and reduced sticking points for any suspended solids flowing from right to left in the hose. See FIGS. 9 and 10.

FIG. 4 shows a portion of the belt as it would be positioned on the mandrel with three sections or teeth 16, 17 and 18 on the belt. The helical member in this Figure is preferably made from a metal wire with a thermoplastic covering. The teeth are shown separated for clarity. In operation, the sidewall of the teeth are in contact with the sidewall of the adjacent tooth. The helical member 11A, 11B and 11C are three convolutes of a single helical member 11. A strip of thermoplastic material 19 is laid across one or more convolutes with the helical member in position. A second strip of thermoplastic material 19b is extruded over at least one of the convolutes with the helical member helical member in position. A third strip of thermoplastic material 19c is extruded over one or more of the convolutes. In practice, however, the three strips 19a-c are a single ribbon of thermoplastic material that is extruded and wrapped around the helix to produce the hose. The edges of the extrudate 19a-c overlap as shown to provide one leg of the V with a greater thickness than the other leg. A roller 20 pushes the thermoplastic wall material into the area square section of the belt. The roller's movement into the soft thermoplastic wall material before it completely hardens causes the formation of a hard living hinge at the bottom of the V & soft hinge in the side in the wall surface. A second living hinge is formed at the intersection of the top layer where the left edge is heat sealed to the layer underneath, 14A in FIG. 3.

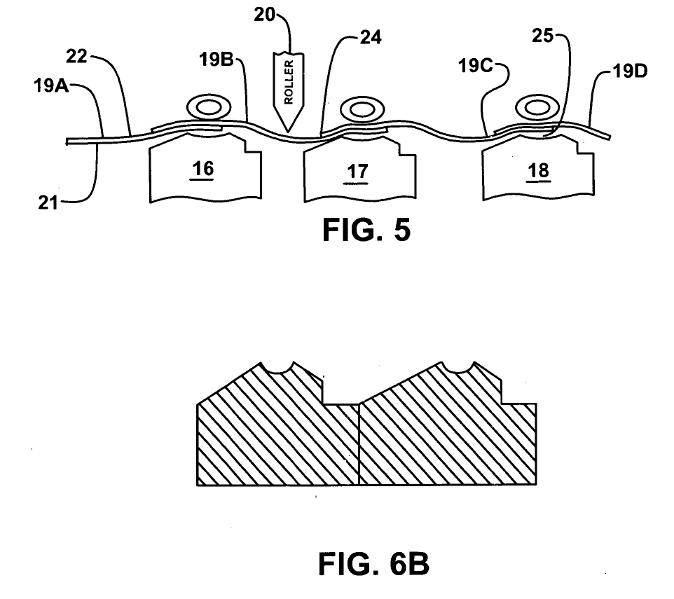

FIG. 5 shows a section of the belt with three teeth 16, 17 and 18. As in FIG. 4, the teeth are shown separated for clarity. In operation, the sidewall of the teeth are in contact with the sidewall of the adjacent tooth as seen in FIG. 11. There are three convolutes of the helical member 11A, 11B and 11C. This is a preferred configuration for a plastic helical member. The plastic helical member is on the outside surface. The plastic member can be extruded onto the outer wall surface The strip of thermoplastic material 19 has been wrapped around the mandrel so that there are a plurality of sections 19A, 19B, 19C and 19D shown. Each of these sections of wall surface have an inner surface 21 and an outer surface 22. In addition, there is a first edge and a second edge 24 and 25. The thermoplastic wall is in the form of a strip that is extruded in the form of molten tape that is wrapped around the mandrel as the mandrel rotates. As seen in FIG. 5 a portion of one edge of the strip on the left side of the strip goes over a portion of the corresponding edge on the right side of the adjacent strip thus forming an area where the thickness of the wall is greater than the adjacent area. The roller extends into the square belt notch on outer surface of the strip to form the two living hinges. The two living hinges permits the square “V” shape when the hose is in a retracted position creating the flat shingle effect.

One way of forming the hose of the present invention is by means of a machine for making flexible conduit of indefinite length these machines typically comprise of a frame and mandrel supported at one end of the frame and free at its opposite end. Means are included for continuously axially rotating and advancing the surface of this mandrel toward the outer end thereof without displacing either end thereof. The helical member can be extruded onto the mandrel. Alternatively, an array of driven helix forming rolls are located adjacent the supporting end of the mandrel for bending a wire into a helical configuration of successive turns around the mandrel. An extruder is provided adjacent the mandrel between the outer end thereof and the helix-forming rolls from which a strip of extruded elastomeric material can be applied about the wire and the mandrel to form a conduit. Fluid jet means are located adjacent the mandrel and extruder for directing a stream of fluid forcibly against the newly formed conduit before the elastomeric material sets to depress the material closely against the wire and the mandrel. Means are provided between the outer end of the mandrel and the fluid jet means for cooling the elastomeric material to below its setting temperature. The apparatus includes a closed-loop flexible belt which is directed around a pulley yo the mandrel core at a slight angle with respect to the mandrel core axis so that it passes in edge engagement with the working surface of the feed cam and is wrapped about the drive teeth. A multiplicity of lateral gripping teeth are formed on the underside of the belt and register able with the drive teeth and the helical key. Thus the belt is positively gripped by the rotating core at the drive teeth and successive convolutions are wrapped about the core. The device is shown in more detail in the Hall patents identified above which are incorporated herein by reference.

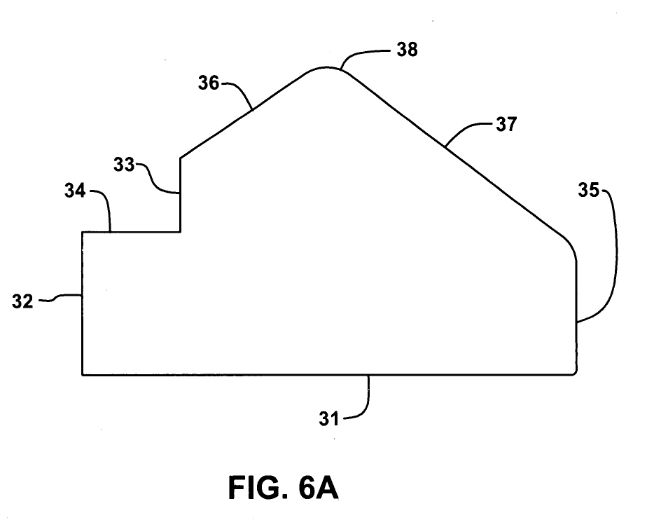

FIG. 6A shows a side section view of a tooth 30 on the belt that is used on a mandrel of the machine used to make the hose of the present invention. The tooth has a base 31 and on one side of the base extending upwardly there from a first sidewall 32, a second sidewall section 33. The first section and second sections are separated by a shoulder 34 that is preferably generally parallel to the base of the tooth. On the opposite side of the base there is a first angled sidewall 36. The first and second sidewall sections are preferably perpendicular to the base and the shoulder. The second sidewall section 33 ends in an angled surface 36. The first angled sidewall 35 ends in a second angled surface 37. Angled surface 36 and angled surface 37 meet at apex 38. It will be noted that the length of angled surface 36 is shorter than angled surface 37. The purpose of the difference in length is to provide the hose with a levering hinge that can be shingled when the hose is retracted configuration.

FIG. 6B shows a side section of a pair of teeth 70 on a belt. The tooth has a base 71 and on one side of the base extending upwardly there from a first sidewall 72, a second sidewall section 73. The first section and second sections are separated by a shoulder 74 that is preferably generally parallel to the base of the tooth. On the opposite side of the base there is a first angled sidewall 76. The first and second sidewall sections are preferably perpendicular to the base and the shoulder. The second sidewall section 73 ends in an angled surface 76. The first angled sidewall 75 ends in a second angled surface 77. Angled surface 76 and angled surface 77 terminate at apex 78 and 79 respectively. There is a curved recess 80 between the two apexes. It will be noted that the length of angled surface 76 is shorter than angled surface 77.

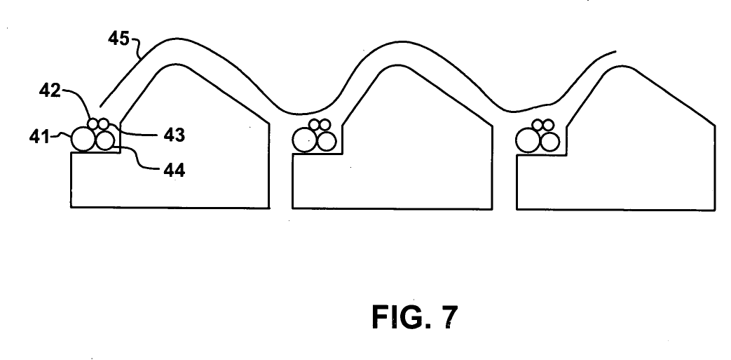

FIG. 7 shows a plurality of teeth of the belt with the helical core 41 and several electrical conduction 42, 43, and 44. A thermoplastic layer 45 is extruded over the teeth.

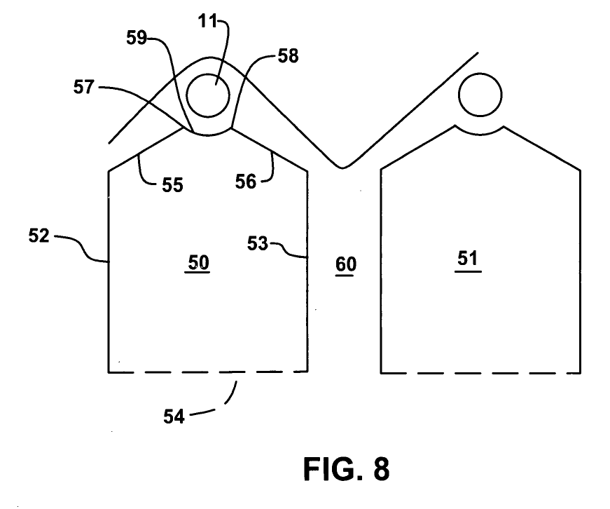

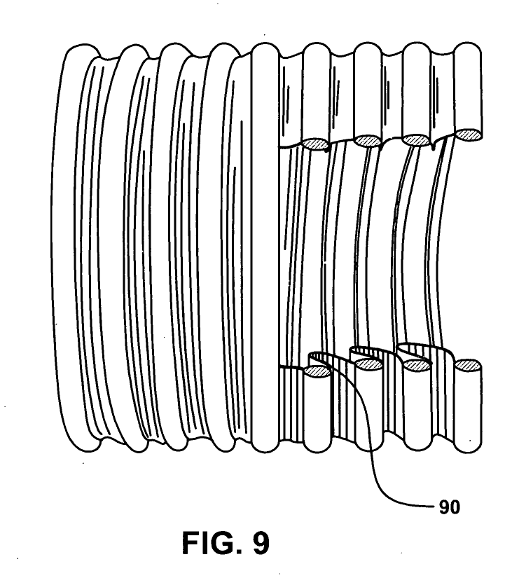

FIG. 8 shows an alternative embodiment of the teeth and the belt. There are two teeth 50 and 51 shown. These are just two of a plurality of teeth on the belt which is over the mandrel. The teeth have a first sidewall 52 and a second sidewall 53. The sidewalls extend upwardly from the base 54 generally perpendicular to the base. On the end of the sidewall opposite the base there is an angled surface 55 and 56. Instead of meeting in a single apex there are two apexes 57 and 58 that are separated by curved recess portion 59. The curved recess portion 59 provides a receptacle on the tooth for receiving the helical member. There is a gap 60 between the individual teeth.

FIG. 9 shows a cutaway view of the hose of FIG. 1 where there is the shingling effect 90. When the hose is in a retracted position, the wall surface of the hose folds into a shingle effect that permits low turbulent flow and reduced sticking points for any suspended solids flowing from right to left in the hose. As seen in FIG. 10 the shingle has a hard hinge 91 from the wheel edge and a soft hinge 92 from the side of the wheel.

FIG. 11 shows a portion of the side view of the hose being formed on the mandrel. The wall material 12 has a generally “V” shape. There are two legs of the “V”, a left leg 13 and a right leg 14. As can be seen from FIG. 11, the left leg is slightly longer than the right leg. Because the left leg is slightly longer than the right leg, the apex 15 of the “V” is not centered between the two adjacent helical members 11b and 11c. The shingle formed in FIG. 10 has a hard hinge 15 from the wheel edge and a soft hinge 92 from the side of the wheel.

1. A flexible hose comprising a helical member having a plurality of coils and a wall surface of one or more layers of a thermoplastic polymer material, said layer of thermoplastic polymeric material extending at least from one coil to each of its adjacent coil, said layers having at least one living hinge in said layer between said coils such that when at least one portion of said hose is in an extended condition said hose retains said condition without reverting to its unextended condition.

2. The flexible hose according to claim 1 wherein said helical member is comprised of metal.

3. The flexible hose according to claim 2 wherein said metal helical member has a thermoplastic coating said thermoplastic coating being bonded to said wall surface.

4. The flexible hose according to claim 3 wherein said metal helical member is on an inner surface of said hose.

5. The flexible hose according to claim 1 wherein said helical member is a plastic helix.

6. The flexible hose according to claim 5 wherein said plastic helix has been extruded onto said wall surface.

7. The flexible hose according to claim 5 wherein said plastic helix is on said outer surface of said wall surface.

8. The flexible hose according to claim 1 wherein the wall surface between two adjacent coils has a generally “V” shape.

9. The flexible hose, according to claim 8 wherein the “V” shape has a first and a second leg and wherein one leg is longer than the other leg.

10. The flexible hose, according to claim 8 wherein when the tip of said “V” is not centered between two adjacent coils.

11. The flexible hose according to claim 10 wherein when said hose in an unextended condition, an interior wall surface of said hose between said coils folds into a shingle effect that permits low turbulent flow and reduced sticking points for any solids flowing through said hose.

12. The flexible hose, according to claim 10 wherein at least a portion of the wall surface of one leg of the “V” is thicker than the opposite leg of said “V”.

13. The flexible hose, according to claim 12 wherein there is a second living hinge in the wall surface between adjacent coils.

14. The flexible hose according to claim 13 wherein said second living hinge in the wall surface is present at the edge of the intersection of a top layer of said wall surface with the bottom layer of said wall surface.

15. A method of forming a flexible hose having a helical member and a wall surface of a thermoplastic polymeric material, said hose retaining its shape in an extended condition without reverting to its original unextended condition comprising applying metal wire about a mandrel having a continuous belt on at least a portion of its surface to form a helical member having a plurality of coils, extruding a tape of a polymeric material over said helical member to form a wall surface of said flexible hose, applying a roller to the surface between two adjacent coils of said helix before said thermoplastic material cools to form a living hinge in said wall surface.

16. The method according to claim 15 wherein said roller forms a generally “V” shaped wall surface between said adjacent coils.

17. The method according to claim 16 wherein one leg of said “V” has at least a portion thereof which is thicker than the remainder of said leg the intersection of said thicker portion of said leg and the other portion of said leg forming a second living hinge in said wall surface.

18. A method forming a flexible hose having a helical member and a wall surface of a thermoplastic material, said hose retaining its shape in an extended condition without reverting to its original unextended condition, comprising extruding a tape of a thermoplastic polymeric material onto a mandrel having a continuous belt on at least a portion of its surface, extruding onto said thermoplastic polymeric material a plastic helical member to form a flexible hose having a plurality of coils, applying a roller to the surface between two adjacent coils of said helix before said thermoplastic material cools to form a living hinge in said wall surface.

19. The method according to claim 18 wherein said roller forms a generally “V” shaped wall surface between said adjacent coils.

20. The method according to claim 19 wherein one leg of said “V” has at least a portion thereof which is thicker than the remainder of said leg, the intersection of said thicker portion of said leg and the other portion of said leg forming a second living hinge in said wall surface.
